(19) United States
(12) Patent Application Publication
(10) Pub. No.: US 2004/0109011 A1
(43) Pub. Date: Jun. 10, 2004

(54) Method, apparatus, and program for automatic client side refresh of advanced web pages

(75) Inventor: William David Peterson JR., Cary, NC (US)

Correspondence Address: Gregory M. Doudnikoff, IBM Corporation T81/503, PO Box 12195, Research Triangle Park, NC, 27709, US

(73) Assignee: International Business Machines Corporation, Armonk, NY

(21) Appl. No.: 10/315,736

(22) Filed: Dec. 10, 2002

(51) Int. Cl. G09G 5/00

(52) U.S. Cl. 345/700

(57) ABSTRACT

A refresh mechanism is provided for dynamic Web pages. A graphical user interface is provided for mimicking a pointer function. A graphical slider allows a user to set a refresh interval. The user may also set a pointer location to mimic. When the refresh mechanism is enabled, the mechanism will perform the pointer function at the pointer location each time the refresh interval expires. The refresh mechanism may be programmed as part of a Web browser, a plug-in for a Web browser, or as a separate application.

### BACKGROUND OF THE INVENTION

1. Technical Field

The present invention relates to network data processing and, in particular, to dynamic content in a network data processing system. Still more particularly, the present invention provides a method, apparatus, and program for automatic client side refresh of advanced web pages.

2. Description of Related Art

Documents are stored on the Internet in “Web servers” that store and disseminate “Web pages.” The Web pages are accessed by the user with software called a “Web browser.” Web pages may contain text, graphics, video, as well as hypertext links. Hypertext links in a page let users navigate from page to page whether the pages are stored on the same server or on servers around the world.

Recently, the World Wide Web has become the center of Internet activity, because the Web browser provides an easy, point-and-click interface to the largest collection of online information in the world. In addition, the Web has become a multimedia delivery system as new browser features and plug-in extensions allow for audio, video, telephony, 3-D animations and videoconferencing. The fundamental Web format is a text document embedded with HTML tags that provide the formatting of the page as well as the hypertext links (URLS) to other pages.

Dynamic Web pages are pages that may be dynamically customized for a user. For example, a Web page may present the results of a search or statistics of an ongoing sports event. These pages may include a script, such as Java Script. Web pages may also include other mechanisms for customizing content, such as Java and Active Server Page (ASP).

Java Script is a popular scripting language that is widely supported in Web browsers and other Web tools. Java Script adds interactive functions to HTML pages, which are otherwise static, since HTML is a display language, not a programming language. Most browsers also support the Java language, which allows applications to be downloaded from the Net and run locally. ASP is a Web server technology that allows for the creation of dynamic, interactive sessions with the user. An ASP is a Web page that contains HTML and embedded programming code. When an ASP page is requested by the browser, the server executes the embedded program.

Dynamic Web pages may include time-sensitive content. However, many dynamic Web pages lack a timed update mechanism to allow the content to be updated consistently. Other dynamic Web pages may automatically update less frequently than the user wishes. Therefore, the user must repeatedly click a hyperlink to generate the dynamic page. Alternately, the user may need to repeatedly perform a manual refresh of the page.

Therefore, it would be advantageous to provide an improved refresh mechanism for advanced dynamic Web pages.

### SUMMARY OF THE INVENTION

The present invention provides a refresh mechanism for dynamic Web pages. A graphical user interface is provided for mimicking a pointer function. A graphical slider allows a user to set a refresh interval. The user may also set a pointer location to mimic. When the refresh mechanism is enabled, the mechanism will perform the pointer function at the pointer location each time the refresh interval expires. The refresh mechanism may be programmed as part of a Web browser, a plug-in for a Web browser, or as a separate application.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A-4C are example screens of display for dynamic Web pages generated and displayed in accordance with a preferred embodiment of the present invention;

FIG. 5 is a block diagram of a browser program including a refresh tool in accordance with a preferred embodiment of the present invention;

FIG. 6 is an exemplary block diagram of a refresh tool in accordance with a preferred embodiment of the present invention; and

FIG. 7 is a flowchart illustrating the operation of a refresh tool in accordance with a preferred embodiment of the present invention.

### DETAILED DESCRIPTION OF THE PREFERRED EMBODIMENT

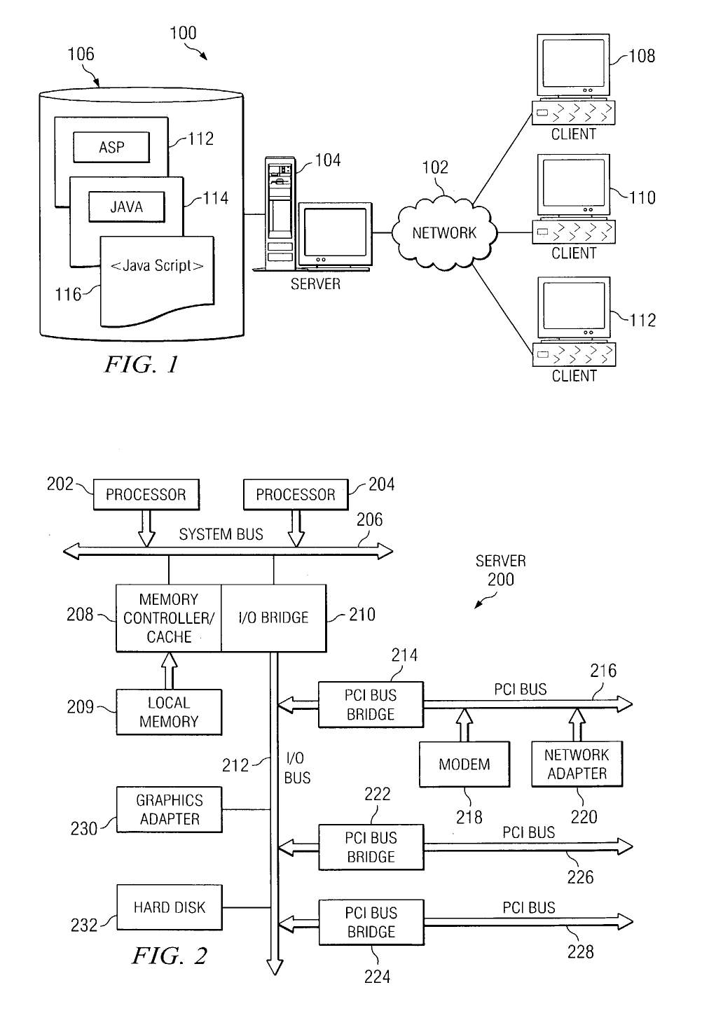

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102. Server 104 provides access to storage unit 106 for clients 108, 110, 112. In addition, clients 108, 110, and 112 are connected to network 102. These clients 108, 110, and 112 may be, for example, personal computers or network computers. In the depicted example, server 104 may provide data, such as boot files, operating system images, and applications to clients 108-112. Clients 108, 110, and 112 are clients to server 104. Network data processing system 100 may include additional servers, clients, and other devices not shown.

In a preferred embodiment of the present invention, server 104 provides data from storage unit 106, including Web pages 112, 114, 116. The Web pages may be, for example, HyperText Markup Language (HTML) documents. According to the preferred embodiment of the present invention, Web pages 112, 114, 116 are dynamic Web pages. Web page 112 has Active Server Page (ASP) code embedded therein. Web page 114 has a Java applet associated therewith. And, Web page 116 has a Java Script embedded therein.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

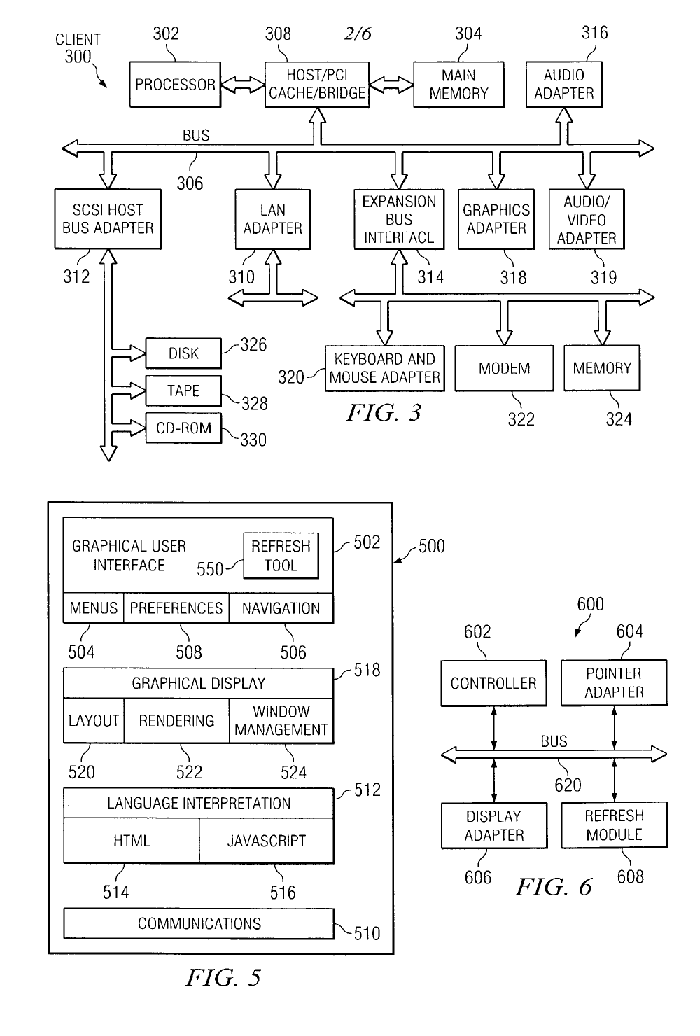

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

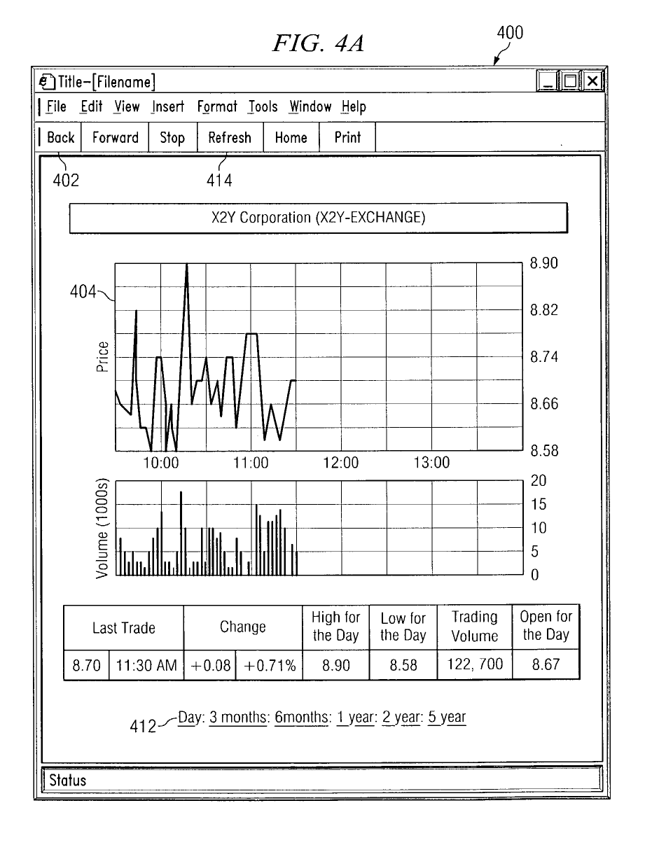

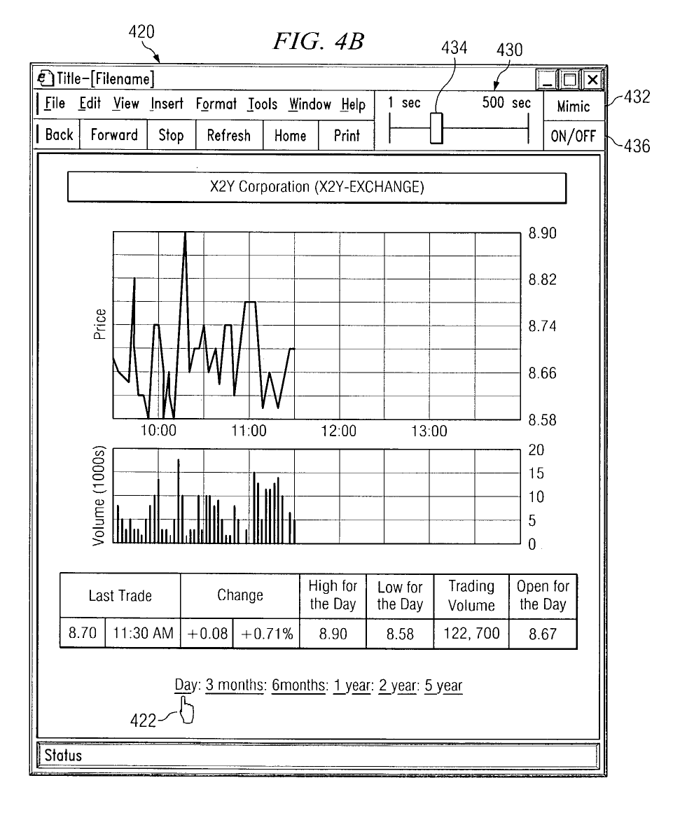

With reference to FIGS. 4A-4C, example screens of display are illustrated for dynamic Web pages generated and displayed in accordance with a preferred embodiment of the present invention. More particularly, FIG. 4A illustrates an initial display of an advanced Web page. The screen comprises browser window 400, including a button tool bar 402. Buttons to be selected from tool bar 402 may include “Back,” “Forward,” “Stop,” “Refresh,” “Home,” and “Print.” However, button tool bar 402 may include fewer or more buttons, as understood by a person of ordinary skill in the art.

The browser window display area presents Web page 404, which may be a dynamically generated Web page. In the example shown in FIG. 4A, the dynamically generated Web page is a stock quote page. A user may wish to leave the page displayed in a browser to track changes in the stock quote over time. Some advanced Web pages can be refreshed from the server, using a server applet. However, many servers generate the page once and deliver the generated page to the client. The user must then refresh the page at the client in order to update the page.

In the example browser screen shown in FIG. 4A, the user may manually refresh or update the page by selecting a link, such as the “Day” link 412. The user may also refresh the page by activating a navigation function, such as by selecting “Refresh” button 414 on tool bar 402. The document would then be regenerated at the server or at the client using, for example a JavaScript, Java applet, or advanced server page. However, the act of repeatedly selecting a link or button is a tedious and monotonous task, which may frustrate the user or prevent the user from performing other, more important tasks.

In accordance with a preferred embodiment of the present invention, a refresh tool is provided for automatic refresh of dynamic Web pages. Turning now to FIG. 4B, a browser window 420 with a graphical refresh tool is shown in accordance with a preferred embodiment of the present invention. A graphical refresh tool 430 is provided for mimicking a pointer function. In this example, the graphical refresh tool is provided as a separate graphical element, rather than being incorporated into the browser display. Graphical refresh tool 430 may be part of the browser application or a browser plug-in.

Using the graphical refresh tool, the user may set a pointer location to mimic by selecting “Mimic” button 432 and subsequently performing a pointer function at a particular pointer location. For example, the user may select the “Mimic” button and select link 422. Graphical slider 434 allows a user to set a refresh interval. Alternatively, the graphical controls in the refresh tool may include other user interface controls, such as, for example, number or text fields, drop-down boxes, radio buttons, or graphical dials. Other modifications may be made to the graphical refresh tool without departing from the spirit and scope of the present invention.

When the refresh tool is enabled, the mechanism will perform the pointer function at the pointer location each time the refresh interval expires. In the example shown in FIG. 4B, the refresh interval may be set to a value between one second and five hundred seconds. The refresh tool may be toggled on and off using “ON/OFF” button 436 in the graphical refresh tool.

Turning now to FIG. 4C, browser window 440 is shown with a graphical refresh tool 450 in accordance with a preferred embodiment of the present invention. Graphical refresh tool 450 is provided for mimicking a pointer function. In this example, the graphical refresh tool is provided as a separate graphical element, rather than being incorporated into the browser display. Graphical refresh tool 450 may be part of the browser application, a browser plug-in, or a separate application.

Using the graphical refresh tool, the user may set a pointer location to mimic by selecting “Mimic” button 452 and subsequently performing a pointer function at a particular pointer location. For example, the user may select the “Mimic” button and select “Refresh” button 444. Graphical slider 454 allows a user to set a refresh interval. When the refresh tool is enabled, the mechanism will perform the pointer function at the pointer location each time the refresh interval expires. The refresh tool may be toggled on and off using “ON/OFF” button 456 in the graphical refresh tool.

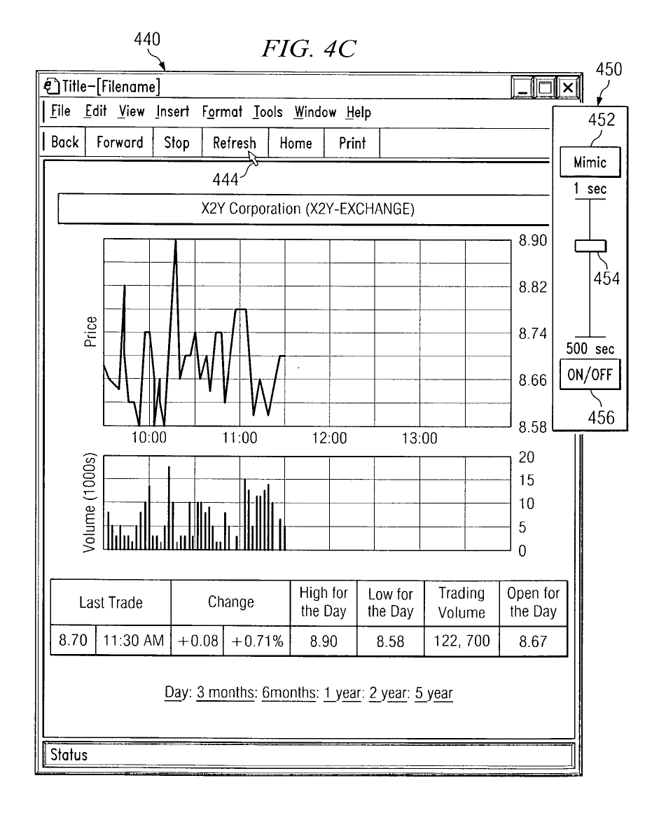

Turning next to FIG. 5, a block diagram of a browser program including a refresh tool is depicted in accordance with a preferred embodiment of the present invention. A browser is an application used to navigate or view information or data in a distributed database, such as the Internet or the World Wide Web.

In this example, browser 500 includes a user interface 502, which is a graphical user interface(GUI) that allows the user to interface or communicate with browser 500. This interface provides for selection of various functions through menus 504 and allows for navigation through navigation 506. For example, menu 504 may allow a user to perform various functions, such as saving a file, opening a new window, displaying a history, and entering a URL. Navigation 506 allows for a user to navigate various pages and to select web sites for viewing. For example, navigation 506 may allow a user to see a previous page or a subsequent page relative to the present page. Preferences may be set through preferences 508.

In accordance with a preferred embodiment of the present invention, Graphical user interface 502 includes refresh tool 550. The refresh tool allows the user to mimic a pointer function. The refresh tool includes a graphical slider that allows a user to set a refresh interval. The user may also set a pointer location to mimic. When the refresh tool is enabled, the tool will perform the pointer function at the pointer location each time the refresh interval expires. Refresh tool may be presented as a graphical user interface, such as graphical refresh tool 430 in FIG. 4B or graphical refresh tool 450 in FIG. 4C.

Communications 510 is the mechanism with which browser 500 receives documents and other resources from a network such as the Internet. Further, communications 510 is used to send or upload documents and resources onto a network. In the depicted example, communication 510 uses HTTP. Other protocols may be used depending on the implementation. Documents that are received by browser 500 are processed by language interpretation 512, which includes an HTML unit 514 and a JavaScript unit 516. Language interpretation 512 will process a document for presentation on graphical display 518. In particular, HTML statements are processed by HTML unit 514 for presentation while JavaScript statements are processed by JavaScript unit 516.

Graphical display 518 includes layout unit 520, rendering unit 522, and window management 524. These units are involved in presenting web pages to a user based on results from language interpretation 512.

Browser 500 is presented as an example of a browser program in which the present invention may be embodied. Browser 500 is not meant to imply architectural limitations to the present invention. Presently available browsers may include additional functions not shown or may omit functions shown in browser 500. A browser may be any application that is used to search for and display content on a distributed data processing system. Browser 500 may be implemented using known browser applications, such as Netscape Navigator or Microsoft Internet Explorer. Netscape Navigator is available from Netscape Communications Corporation while Microsoft Internet Explorer is available from Microsoft Corporation.

FIG. 6 is an exemplary block diagram of a refresh tool in accordance with a preferred embodiment of the present invention. Refresh tool 600 includes controller 602, pointer adapter 604, display adapter 606, and refresh module 608. The elements 602-608 may be implemented as hardware, software, or a combination of hardware and software. In a preferred embodiment, the elements 604-608 are implemented as software instructions executed by one or more processors.

The elements 602-608 are coupled to one another via the control/data signal bus 620. Although a bus architecture is shown in FIG. 6, the present invention is not limited to such. Rather, any architecture that facilitates the communication of control/data signals between elements 602-608 may be used without departing from the spirit and scope of the present invention. The controller 602 controls the overall operation of the refresh module and orchestrates the operation of the other elements 604-608.

With the operation of the present invention, refresh module 608 instructs controller 602 to receive pointer operations from pointer adapter 604, to display graphical interface controls, such as, for example a mimic button, refresh interval slider, and an on/off button, through display adapter 606, and to mimic pointer operations as if they are received from pointer adapter 604.

The pointer operations received from the pointer adapter may include interactions with the graphical interface controls. For example, a pointer operation may be received that sets the refresh interval by interacting with a slider control. However, a pointer operation received from the pointer adapter may also be identified as the refresh operation to be mimicked. When refresh tool 600 is enabled, the tool will mimic the refresh operation at the pointer location each time the refresh interval expires. Refresh module 608 may be programmed as part of a Web browser, a plug-in for a Web browser, or as a separate application

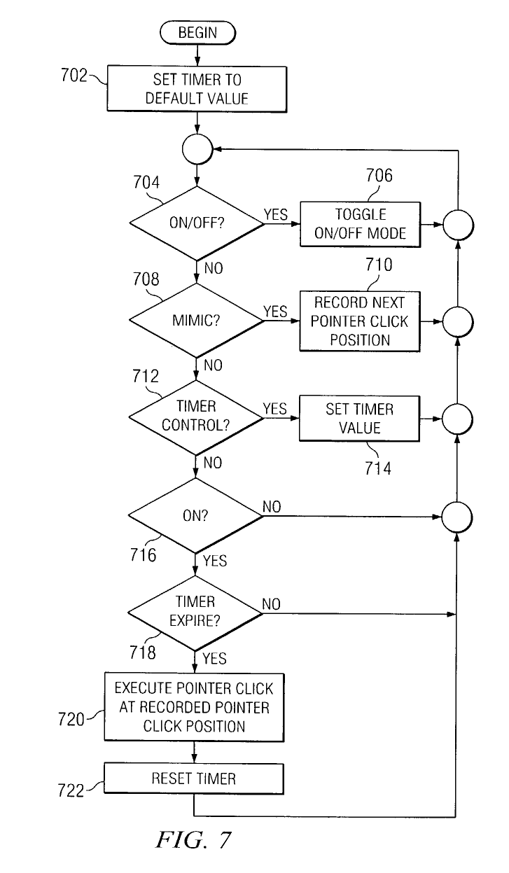

With reference now to FIG. 7, a flowchart illustrating the operation of a refresh tool is shown in accordance with a preferred embodiment of the present invention. The process begins and sets a refresh timer to a default value (step 702). Next, a determination is made as to whether an on/off toggle control is selected (step 704). If the on/off toggle control is selected, the process toggles the mode of the refresh tool on or off accordingly (step 706) and returns to step 704 to determine whether an on/off toggle control is selected.

If the on/off toggle control is selected in step 704, a determination is made as to whether a mimic control is selected (step 708). If the mimic control is selected, the process records the next pointer click position (step 710) and returns to step 704 to determine whether an on/off toggle control is selected.

If the mimic control is not selected in step 708, a determination is made as to whether interaction with a refresh timer control is received (step 712). If interaction with the refresh timer control is received, the process sets the refresh timer value accordingly (step 714) and returns to step 704 to determine whether an on/off toggle control is selected.

If interaction with the refresh timer control is not received in step 712, a determination is made as to whether the refresh tool is in an “on” mode (step 716). If the refresh tool is not in an “on” mode, the process returns to step 704 to determine whether an on/off toggle control is selected. If, however, the refresh tool is in an “on” mode in step 716, a determination is made as to whether the refresh timer is expired (step 718). If the refresh timer is not expired, the process returns to step 704 to determine whether an on/off toggle control is selected.

If the refresh timer is expired in step 718, the process executes a pointer click at the recorded pointer click position (step 720), resets the refresh timer (step 722), and returns to step 704 to determine whether an on/off toggle control is selected.

Thus, the present invention solves the disadvantages of the prior art by providing a refresh mechanism for automatically performing a refresh operation for dynamic Web pages without interaction from the user for each refresh operation. A graphical user interface is provided for mimicking a pointer function. A graphical slider allows a user to set a refresh interval. The user may also set a pointer location to mimic. When the refresh mechanism is enabled, the mechanism will perform the pointer function at the pointer location each time the refresh interval expires. The refresh mechanism may be programmed as part of a Web browser, a plug-in for a Web browser, or as a separate application.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for refreshing a dynamically generated document, comprising:
receiving a dynamically generated document from a server;
recording a pointer operation and a pointer location for the pointer operation; and
automatically repeating the pointer operation at the recorded pointer location without interaction from the user, wherein the pointer operation results in receiving the dynamically generated document to form an updated dynamically generated document.

2. The method of claim 1, wherein the dynamically generated document includes one of a JavaScript, a Java applet, and an Active Server Page.

3. The method of claim 1, wherein the step of recording a pointer operation and a pointer location includes:
presenting a refresh tool including a mimic control for recording a refresh operation; and
responsive to selection of the mimic control, receiving the pointer operation and the pointer location as the refresh operation.

4. The method of claim 3, wherein the refresh tool includes a timer control for setting a refresh interval.

5. The method of claim 4, wherein the step of automatically repeating the pointer operation includes repeating the pointer operation upon expiration of the refresh interval.

6. The method of claim 4, wherein the timer control is a graphical slider control.

7. The method of claim 1, wherein the pointer operation is one of a selection of a hyperlink and a selection of a refresh navigation function.

8. A method for mimicking a pointer function, comprising:
setting a refresh interval;
recording a pointer operation and a pointer location for the pointer operation; and
upon expiration of the refresh interval, repeating the pointer operation at the recorded pointer location without interaction from the user.

9. The method of claim 8, wherein the step of recording a pointer operation and a pointer location includes:
presenting a refresh tool including a mimic control for recording a refresh operation; and
responsive to selection of the mimic control, receiving the pointer operation and the pointer location as the refresh operation.

10. The method of claim 8, wherein the step of setting a refresh interval includes:
presenting a refresh tool including a timer control for setting the refresh interval; and
setting the refresh interval based on the timer control.

11. The method of claim 10, wherein the timer control is a graphical slider control.

12. An apparatus for refreshing a dynamically generated document, comprising:
receipt means for receiving a dynamically generated document from a server;
recordation means for recording a pointer operation and a pointer location for the pointer operation; and
refresh means for automatically repeating the pointer operation at the recorded pointer location without interaction from the user, wherein the pointer operation results in receiving the dynamically generated document to form an updated dynamically generated document.

13. The apparatus of claim 12, wherein the dynamically generated document includes one of a JavaScript, a Java applet, and an Active Server Page.

14. The apparatus of claim 12, wherein the recordation means includes:
presentation means for presenting a refresh tool including a mimic control for recording a refresh operation; and
means, responsive to selection of the mimic control, for receiving the pointer operation and the pointer location as the refresh operation.

15. The apparatus of claim 14, wherein the refresh tool includes a timer control for setting a refresh interval.

16. The apparatus of claim 15, wherein the refresh means includes means for repeating the pointer operation upon expiration of the refresh interval.

17. The apparatus of claim 15, wherein the timer control is a graphical slider control.

18. The apparatus of claim 12, wherein the pointer operation is one of a selection of a hyperlink and a selection of a refresh navigation function.

19. An apparatus for mimicking a pointer function, comprising:
setting means for setting a refresh interval;
recordation means for recording a pointer operation and a pointer location for the pointer operation; and
repetition means, upon expiration of the refresh interval, for repeating the pointer operation at the recorded pointer location without interaction from the user.

20. The apparatus of claim 19, wherein the recordation means includes:
means for presenting a refresh tool including a mimic control for recording a refresh operation; and
means, responsive to selection of the mimic control, for receiving the pointer operation and the pointer location as the refresh operation.

21. The apparatus of claim 19, wherein the setting means includes:
means for presenting a refresh tool including a timer control for setting the refresh interval; and
means for setting the refresh interval based on the timer control.

22. The apparatus of claim 21, wherein the timer control is a graphical slider control.

23. A computer program product, in a computer readable medium, for refreshing a dynamically generated document, comprising:
instructions for receiving a dynamically generated document from a server;
instructions for recording a pointer operation and a pointer location for the pointer operation; and
instructions for automatically repeating the pointer operation at the recorded pointer location without interaction from the user, wherein the pointer operation results in receiving the dynamically generated document to form an updated dynamically generated document.

24. A computer program product, in a computer readable medium, for mimicking a pointer function, comprising:
instructions for setting a refresh interval;
instructions for recording a pointer operation and a pointer location for the pointer operation; and
instructions, upon expiration of the refresh interval, for repeating the pointer operation at the recorded pointer location without interaction from the user.
